(19) United States
(12) Patent Application Publication
(10) Pub. No.: US 2010/0115702 A1
(43) Pub. Date: May 13, 2010

(54) Foam and Honeycomb Mattress

(76) Inventors: Lydia B. Biggie, Lighthouse Point, CA (US); David M. Genaro, North Lauderdale, FL (US); Charles Curtis Wyatt, Corona, CA (US)

Correspondence Address: NIXON & VANDERHYE, PC, 901 NORTH GLEBE ROAD, 11TH FLOOR, ARLINGTON, VA, 22203, US

(21) Appl. No.: 12/597,586

(22) PCT Filed: Apr. 17, 2008
(86) PCT No.: PCT/US08/04931

§ 371 Date: Oct. 26, 2009

Related U.S. Application Data
(60) Provisional application No. 60/913,603, filed on Apr. 24, 2007.

(51) Int. Cl. A47C 27/00; B32B 3/26; B32B 3/12

(52) U.S. Cl. 5/690; 428/71; 5/699

(57) ABSTRACT

A support surface includes a foam base layer including a foam bottom layer and a pair of foam side edges disposed adjacent sides of the foam bottom layer. The foam side edges are firmer than the foam bottom layer. A honeycomb material layer is disposed over the foam base layer, and a cover surrounds the foam base layer and the honeycomb material layer. The combination of foam and honeycomb material provides an effective support surface resulting in superior pressure relieving characteristics, resistance to bottoming out, good edge support, and reduced manufacturing costs.

This application claims the benefit of U.S. Provisional Patent Application Ser. No. 60/913,603, filed Apr. 24, 2007, the entire content of which is herein incorporated by reference.

### BACKGROUND AND SUMMARY

A honeycomb structure “SupraCor” has been developed to use as a mattress overlay. An overlay is placed on a hospital mattress and provides better pressure relief than just the standard hospital mattress. In fact, U.S. Pat. No. 5,701,621 to Landi entitled “Liner for overlaying a mattress” specifically calls out this application of honeycomb structure.

An overlay by its very nature cannot be very thick. This is because it is placed on the top of a hospital mattress or the like adding to the overall height of mattress. If the total height is increased too much, the side rails become ineffective and could be a potential danger for the patient. Thin overlays, however, make it easy for the patient to bottom-out, whereby the weight of the patient causes them to hit the underneath surface, and hence, the patients are not supported by the overlay itself. A thin overlay is thus most effective on lightweight patients.

Honeycomb, as described in the noted '621 patent as well as U.S. Pat. Nos. 5,039,576 and 5,180,619, consists of undulating vertical strips of resilient thermoplastic material. The material is thin walled, 2 to 10 mils thick, and as such does not have much strength in compression. In fact, it is this characteristic that makes it a good pressure-relieving surface. However, because of the manufacturing process, the maximum thickness of one layer is 2″. As such, the support surface overlay is constrained to several layers that are no thicker than about 3″ (to avoid a side rail issue) or one layer of maximum 2″ due to manufacturing constraints. As a result of these height constraints, heavy patients bottom out on an overlay utilizing a honeycomb construction.

There is a need, therefore, for a mattress replacement that incorporates a honeycomb construction, but that prevents bottoming out, while at the same time avoiding the potential risk of being too high for side rail protection.

An overlay, and in particular an overlay made out of 100% honeycomb structure also has the disadvantage of lacking edge support. Edge support on a mattress prevents a mattress from collapsing as a patient puts weight on its edge. Edge support is important to prevent entrapment of the patient between the mattress and the side rails. Entrapment has caused numerous patient deaths. Honeycomb structure alone cannot have a firm enough edge to prevent entrapment. Therefore, there is also a need to have a honeycomb structure and a firmer substrate such as foam where the edge of the mattress is constructed of very stiff foam to provide suitable edge support.

As previously mentioned, the thin wall honeycomb material has little strength in compression, which in fact makes it ideal as a pressure relief construction. However, in order for the honeycomb to be tear resistant and have the ability to hold up under constant use, the very thin material must be carefully chosen. For instance, very thin urethane is many times stronger and resists tears more than a very thin vinyl. It is desirable , therefore, to use urethane as the honeycomb structure. In fact, the Landi patents reference the use of such a urethane material. Urethane, however, is a very expensive material as compared to foam. Therefore, an overlay constructed out of 100% silicon honeycomb is at least five to ten times more expensive than a similar sized overlay made out of foam alone. Utilizing a combination of foam and honeycomb can thus reduce the cost compared to a honeycomb only support surface.

Utilizing a combination of foam and honeycomb can provide an effective support surface that addresses the drawbacks of using honeycomb only while retaining the advantages of the honeycomb material.

To protect the foam and honeycomb support surface from contamination of solids and liquids, it is desirable to have a breathable yet water proof cover encase the foam and honeycomb structure. This greatly extends the life of the mattress, preventing contamination from entering the foam and honeycomb, and allowing adherence of infection control policies by the medical facility. The breathable cover also is more superior in healing/preventing wounds than a standard non-breathable cover. It prevents moisture and heat buildup, and has very low shear and friction to the skin. Therefore, a breathable yet waterproof cover not only protects the foam and honeycomb structure, but aids in the healing of wounds.

In the rental of support surfaces, the Medicare reimbursement for a mattress replacement is significantly more than the reimbursement for a mattress overlay. So even though the cost for a mattress replacement made out of foam plus honeycomb might be more than an overlay made out of 100% honeycomb, the life cycle payback for dealers offering the rental service to medical facilities is better. Therefore, dealers would prefer a mattress replacement rather than an overlay.

It would be desirable to make a mattress replacement having a total height of about 5 to 9 inches to avoid side rail problems (preferably at least 5½ inches), with a combination of foam and honeycomb to have superior pressure relieving characteristics, prevent bottoming out, have good edge support to avoid patient entrapment, lower manufacturing cost compared to a 100% honeycomb mattress replacement, and to meet market demands from dealers. It would additionally be desirable to utilize honeycomb material as the top layer with foam under for superior pressure relieving characteristics and to utilize “zones” of varying physical characteristics for pressure distribution.

Comparison to Constructions Described in Landi Patents

Landi in U.S. Pat. No. 5,701,621 describes an object of its invention “to provide an improved pad or liner for a mattress that can be constructed with desired cushioning and stabilizing characteristics without having to introduce elements such as foam, gels or other elements which add cost or reduce durability.” The '621 patent also describes shortcomings associated with foam materials. In particular, the '621 patent describes that foams need to be encased in an impermeable covering because foam readily absorbs fluids. Landi therefore does not intend for the mattress overlay to have foam as part of its construction.

The '621 patent, which is for a honeycomb only overlay, also specifically claims an “encasing which is made out of a material that is permeable to fluids.” Fluid can mean air or water. Therefore, both water and air can pass through the cover or encasing. It is rather desirable to have a moisture proof, yet vapor permeable (“breathable”) top cover for the mattress replacement made out of honeycomb plus foam. The cover would be permeable to moisture vapor (a gas), yet impermeable to water or other liquids, unlike Landi's cover.

In an exemplary embodiment, a support surface includes a foam base layer including a foam bottom layer and a pair of foam side edges disposed adjacent sides of the foam bottom layer. The foam side edges are firmer than the foam bottom layer. A honeycomb material layer is disposed over the foam base layer, and a cover surrounds the foam base layer and the honeycomb material layer. In one arrangement, the foam bottom layer includes a plurality of foam support zones that vary in physical characteristics from zone to zone. In one example, the foam bottom layer includes a head zone, a central zone, and a foot zone, and the central zone is firmer than the head zone and the foot zone. Generally, the varying physical characteristics of the foam support zones include at least one of thickness, density, firmness, and stiffness. The support surface may additionally include a foam head section and a foam foot section disposed adjacent opposite ends of the honeycomb material layer on top of the foam base layer.

The honeycomb material layer may similarly include a plurality of honeycomb support zones that vary in physical characteristics from zone to zone, including, for example, a head zone, a central zone, and a foot zone, where the central zone is firmer than the head zone and the foot zone. Preferably, the honeycomb material layer is disposed between the foam side edges. Additional foam side edges may be provided.

In another exemplary embodiment, a mattress replacement includes a foam base layer including foam edge supports, and a honeycomb material layer disposed on top of the foam base layer. Each of the foam base layer and the honeycomb material layer is constructed with multiple zones of varying physical characteristics. A cover may be provided surrounding the foam base layer and the honeycomb material layer.

### BRIEF DESCRIPTION OF THE DRAWINGS

These and other aspects and advantages of the present invention will be described in detail with reference to the accompanying drawings, in which:

FIG. 1 is an exploded perspective view of the support surface of an exemplary embodiment; and

FIG. 2 is a perspective view of an assembled support surface.

### DETAILED DESCRIPTION OF THE INVENTION

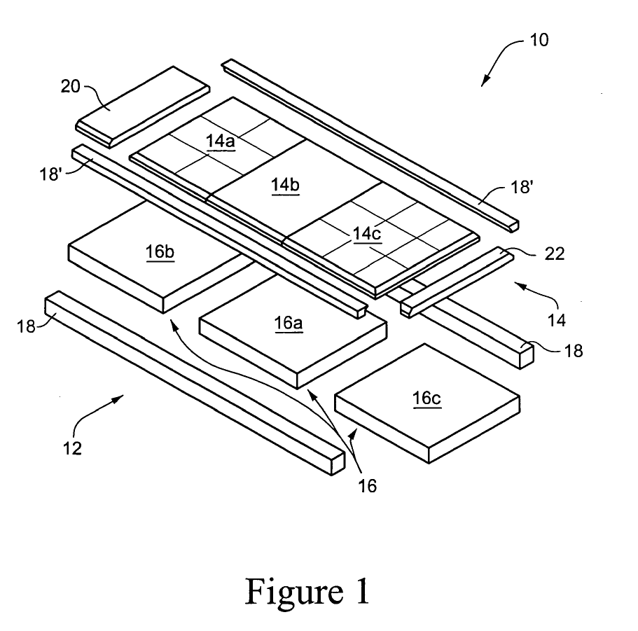

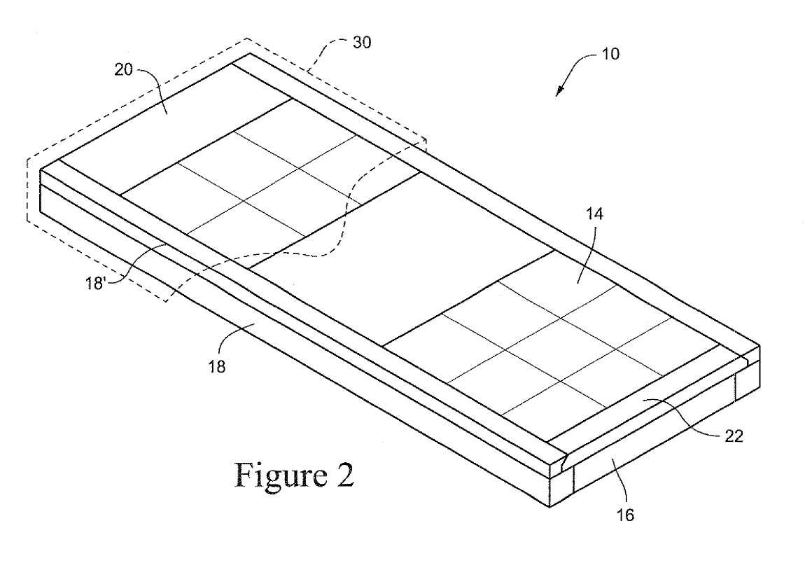

With reference to FIGS. 1 and 2, in an exemplary embodiment, a full hospital mattress replacement 10 includes a foam base or crib 12 and a layer (or layers) of honeycomb material 14. The honeycomb material can be as specified in the noted '567 and '619 patents or may be similarly constructed. The mattress replacement 10 preferably also has a breathable moisture-proof cover 30 (shown cutaway in dashed line in FIG. 2) covering the assembly.

The foam crib 12 includes a bottom layer 16. A very firm rectangular shaped edge 18 is preferably provided along both of the long sides of the mattress as shown, and optional head and foot foam edges 20, 22 may also be provided. Additional edges 18′ may be adhered to the firm edges 18 via an adhesive or the like for additional support.

The foam bottom layer 16 may be provided with different zones with varying physical characteristics, i.e., a more firm foam 16a used under the buttocks and trunk, a less firm foam 16b under the head portion, and a softer foam 16c under the heels. This variation in the densities of foam allow for better pressure relief based on the weight distribution of the body.

The firm edges 18 provide good edge support to the mattress, preventing entrapment of the patient.

The optional foams at the head 20 and foot 22 of the mattress aid in supporting the side edge supports 18 and keeping them vertical. The foams 20, 22 also reduce the area of honeycomb structure, thereby lowering the cost of the complete mattress. This reduced area, however, does not compromise the pressure relieving characteristics of the mattress. For instance, if there is some foam at the head 20, this portion of the mattress is almost always covered by a pillow.

The honeycomb structure material 14 is provided on top of the foam (or possibly under it) and between the foam edge supports 18. The honeycomb 14 may similarly be provided with distinct zones of different physical characteristics, including different firmness or stiffness for the head 14a, trunk 14b and feet 14c. For either the foam bottom layer 16 or the honeycomb material 14 or both, there may be more than three zones or just one zone. Depending on the thickness, firmness, and zones of the foam bottom layer, any combination of thickness, stiffness, and zones of the honeycomb structure 14 and foam bottom layer 16 could be used.

The cover 30 over the top of the mattress is preferably “breathable,” which means that the cover is impermeable to urine or other liquids, but permeable to gas (water vapor). The breathable cover 30 aids in keeping the skin in good condition by allowing moisture vapor to pass thru the cover.

The combination of foam and honeycomb material provides an effective support surface resulting in superior pressure relieving characteristics, resistance to bottoming out, good edge support, and reduced manufacturing costs. Mattress height can be controlled to avoid side rail problems, and the durable materials will provide for an extended useful life. A breathable cover aids in user comfort.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

1. A support surface comprising:
a foam base layer including a foam bottom layer and a pair of foam side edges disposed adjacent sides of the foam bottom layer, the foam side edges being firmer than the foam bottom layer;
a honeycomb material layer disposed over the foam base layer, the honeycomb material layer defining a topmost support layer of the support surface, wherein the honeycomb material layer is formed of a material and construction that defines a pressure-relieving surface; and
a cover surrounding the foam base layer and the honeycomb material layer.

2. A support surface according to claim I, wherein the foam bottom layer comprises a plurality of foam support zones that vary in physical characteristics from zone to zone.

3. A support surface according to claim 2, wherein the foam. bottom layer comprises a head zone, a central zone, and a foot zone, and wherein the central zone is firmer than the head zone and the foot zone.

4. A support surface according to claim 2, wherein the varying physical characteristics of the foam support zones comprise at least one of thickness, density, firmness, and stiffness.

5. A support surface according to claim 1, further comprising a foam head section and a foam foot section disposed adjacent opposite ends of the honeycomb material layer on top of the foam base layer.

6. A support surface according to claim 1, wherein the honeycomb material layer comprises a plurality of honeycomb support zones that vary in physical characteristics from zone to zone.

7. A support surface according to claim 6, wherein the honeycomb material layer comprises a head zone, a central zone, and a foot zone, and wherein the central zone is firmer than the head zone and the foot zone.

8. A support surface according to claim 6, wherein the varying physical characteristics of the honeycomb support zones comprise at least one of thickness, density, firmness, and stiffness.

9. A support surface according to claim 1, wherein the honeycomb material layer is disposed between the foam side edges.

10. A support surface according to claim 9, further comprising additional foam side edges disposed on top of the foam side edges.

11. A support surface according to claim 1, wherein the cover is formed of a breathable moisture-proof material.

12. A mattress replacement comprising a foam base layer including foam edge supports, and a honeycomb material layer disposed on top of the foam base layer, the honeycomb material layer defining a topmost support layer of the mattress replacement, wherein the honeycomb material layer is formed of a material and construction that defines a pressure-relieving surface, each of the foam base layer and the honeycomb material layer being constructed with multiple zones of varying physical characteristics.

13. A mattress replacement according to claim 12, further comprising a cover surrounding the foam base layer and the honeycomb material layer.

14. A mattress replacement according to claim 13, wherein the cover is formed of a breathable moisture-proof material.
